(19) United States
(12) Patent Application Publication
(10) Pub. No.: US 2025/0388362 A1
(43) Pub. Date: Dec. 25, 2025

(54) CLAMP LOCK

(71) Applicant: UFP INDUSTRIES, INC., Grand Rapids, MI (US)

(72) Inventors: Robert Joseph Bilbrough, III, Ada, MI (US); Nicholas Lee Martinchek, Grand Rapids, MI (US)

(73) Assignee: UFP INDUSTRIES, INC., Grand Rapids, MI (US)

(21) Appl. No.: 18/814,948

(22) Filed: Aug. 26, 2024

Related U.S. Application Data
(60) Provisional application No. 63/661,624, filed on Jun. 19, 2024.

(51) Int. Cl. B65D 6/26; B65D 6/34

(52) U.S. Cl. CPC B65D 9/24; B65D 9/34

(57) ABSTRACT

A clamp lock having a body that includes a first arm, a second arm, a first gripping portion, and a second gripping portion. The first arm includes a first end and a second end. The second arm includes a third end and a fourth end, wherein the second arm extends from the second end of the first arm. The first gripping portion extends from the first end of the first arm and the second gripping portion extends from the fourth end of the second arm. A first grip angle is defined between the first gripping portion and the first arm and a second grip angle is defined between the second gripping portion and the second arm.

### CROSS REFERENCE TO RELATED APPLICATIONS

This application claims the benefit of U.S. Provisional Patent Application No. 63/661,624, filed on Jun. 19, 2024, which is incorporated herein by reference in its entirety.

### BACKGROUND

Crates, also known as containers or boxes, have been used for centuries to move materials or goods from one location to another. When carrying heavy loads, boxes are often made from increasingly stronger materials such as wood or metal. Crates can be designed for single use and disposed of after the transported materials or goods have reached their destination. Alternatively, crates can be reusable or include reusable components.

### BRIEF DESCRIPTION OF THE DRAWINGS

In the drawings:

FIG. 1 is a perspective view of a crate in the form of an industrial packaging crate according to aspects of the present disclosure.

FIG. 2 is a perspective view of an unmounted clamp lock that can be utilized with the crate of FIG. 1 according to aspects of the present disclosure.

FIG. 3 is a side view of the clamp lock of FIG. 2 according to aspects of the present disclosure.

FIG. 4 is a side view of a clamp lock in use according to aspects of the present disclosure.

FIG. 5 is a variation of the clamp lock shown in FIG. 4 according to aspects of the present disclosure.

### DETAILED DESCRIPTION

A crate such as by way of non-limiting example, an industrial packaging crate is usually constructed from pieces of lumber material that are coupled together. The industrial packaging crate can be an open sided crate. Open sided crates can include sidewalls that are removable where the sidewalls are constructed from dimensional lumber. Being constructed from dimensional lumber, the removable sidewalls of an open crate are not required to include a plywood covering. The open sided crate (hereinafter “crate”) includes pre-assembled components, where the components of the crate can include three or more sidewalls, a base, and optionally a top. Optionally, these crates can be secured to wooden pallets, allowing the use of machines to move the crates.

Pre-assembled sidewalls, base, and optional top allow the crate to be quickly assembled and optionally collapsible or reusable. Therefore, there is a great need in the industry for devices that can couple these pre-assembled components of the crate together.

Often the sides of the crate that define a protected or enclosed volume are secured to one another by means of nails, screws, or tightening bands requiring specific tools to fasten to the crate. Existing fasteners that are currently on the market do not fit pre-assembles pieces of the crate. Current fasteners do not fit many combinations of the dimensional lumber pieces used to create various crate models. When the fasteners are applied that do not fit the two dimensional lumber pieces from the adjacent crate components, there can be a loose fit. A loose fit results in at last on of the two components of the crate to be able to move or shift easily. For example, a sidewall that is loose relative to the base can result from using current fasteners. The current fasteners increase safety concerns for humans around the packaging space, logistics, inventory, and end consumers. This also creates security issues for the product inside the crate if one of the fasteners comes off due to looseness.

Conventionally, when clamps are utilized in the crate industry, to obtain a tight fit between the two pieces of dimensions lumber from the two adject crate components, a smaller fastener can be used. However, material from one or more portions of one or both of the dimensions lumber pieces must be removed. Dimensional lumber pieces, such as 1×6 pieces by way of non-limiting example, must be milled down to fit, which results in higher costs associated with the crate such as additional labor, machines, and time costs. That is, to accommodate the fasteners on the market, the dimensional lumber used to make the crate components must be altered. The altering can be milling the dimensional lumber before pre-assembly of the components of the crate. The altering can also include removing a portion of the dimensional lumber after pre-assembly of the components. Further, the dimensional lumber can be routed by computer numerical control (CNC). Milling and CNC can cause safety and security concerns in the removal of material from the crate components, effectively weakening portions of the crate, as well as an extremely high cost that is not marketable for most, if not all, applications.

Milling or other method of removal of material to get the fasteners to fit increases waste generated as the excess material (lumber) that is removed is discarded. This process also increases labor and costs. Such conventional fasteners have been utilized in the market since the 1960s and have not changed, leaving a long felt need for consumers.

Thus, there is a need for an improved crate connector or fastener that closely fits a wide variety of dimensional lumber sizes that are used in industrial packaging crates in order to address the above safety, cost, and waste concerns.

Aspects of the present disclosure relate to clamp locks that can be used, for example, to couple components constructed from dimensional lumber together to form a crate. The clamp locks can, for example, couple at least three sidewalls to a base. The clamp locks can be applied without the altering of the dimensional lumber used to form the at least three sidewalls and at least a portion of the base. Optionally, the clamp locks can couple a fourth sidewall (or more) and/or a top to the sidewalls that are coupled to the base. The dimensional lumber need not be milled or otherwise changed to utilize the clamp lock.

The clamp locks, as described herein, improve safety and lower the overall cost of the crate. The clamp locks reduce the time required to assemble the crates. The clamp locks as described herein couple adjacent dimensional lumber without having to try to bend or adjust the clamp to fit tighter as can be required with a traditional fastener. Further, the clamp locks as described herein couple adjacent dimensional lumber without having to remove material to make the clamp fit as can be required with a traditional fastener. The clamp locks are applicable to all manufacturing fields that require crating to ship their products.

All directional references (e.g., proximal, distal, upper, lower, upward, downward, left, right, lateral, front, back, top, bottom, above, below, vertical, horizontal, etc.) are only used for identification purposes to aid the reader's understanding of the present disclosure, and do not create limitations, particularly as to the position, orientation, or use of aspects of the disclosure described herein. Connection references (e.g., attached, coupled, secured, fastened, and connected,) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order, and relative sizes reflected in the drawings attached hereto can vary.

While “a set of” or “a plurality of” various elements will be described, it will be understood that “a set” or “a plurality” can include any number of the respective elements, including only one element.

As used herein, the term “dimensional lumber” includes dressed lumber having common descriptions. For example, a piece of lumber nominally known or described as a two-by-four (2×4) is a piece of lumber that has two dimensions that measure 1.5 inches by 3.5 inches (approximately 3.81 centimeters and 8.89 centimeters). The name or description “2×4” historically from its sawed dimensions that are closer to approximately two inches by approximately four inches. The sawed 2×4 is dressed before distributing, therefore a 2×4 has actual dimensions of 1.5 inches by 3.5 inches (3.81 centimeters and 8.89 centimeters). That is, the piece of dimensional lumber known as a 2×4 is a piece of lumber that has dimensions that measure 1.5 inches by 3.5 inches (3.81 centimeters and 8.89 centimeters). Dimensional lumber can further include a one-by-two (1×2) having two dimensions that measure 0.75 inches and 1.5 inches (approximately 1.90 centimeters and 3.81 centimeters); a one-by-three (1×3) having two dimensions that measure 0.75 inches and 2.5 inches (approximately 1.90 centimeters and 6.35 centimeters); a one-by-four (1×4) having two dimensions that measure 0.75 inches and 3.5 inches (approximately 1.90 centimeters and 8.89 centimeters); a one-by-six (1×6) having two dimensions that measure 0.75 inches and 5.5 inches (approximately 1.90 centimeters and 13.97 centimeters); a one-by-eight (1×8) having two dimensions that measure 0.75 inches and 7.25 inches (approximately 1.90 centimeters and approximately 18.42 centimeters); a two-by-three (2×3) having two dimensions that measure 1.5 inches and 2.5 inches (3.81 centimeters and 6.35 centimeters); and a two-by-six (2×6) having two dimensions that measure 1.5 inches and 5.5 inches (3.81 centimeters and 13.97 centimeters). Optionally, dimensional lumber can further include a four-by-four (4×4) having two dimensions that both measure 3.5 inches (8.89 centimeters); a four-by-six (4×6) having two dimensions that measure 3.5 inches and 5.5 inches (8.89 centimeters and 13.97 centimeters); a two-by-eight (2×8) having two dimensions that measure 1.5 inches and 7.25 inches (3.81 centimeters and approximately 18.42 centimeters); or a six-by-six (6×6) having two dimensions that both measure 5.5 inches (13.97 centimeters). When the term dimensional lumber is utilized in the remainder of the document it will be understood to mean dimensional lumber that is unaltered from such common descriptions.

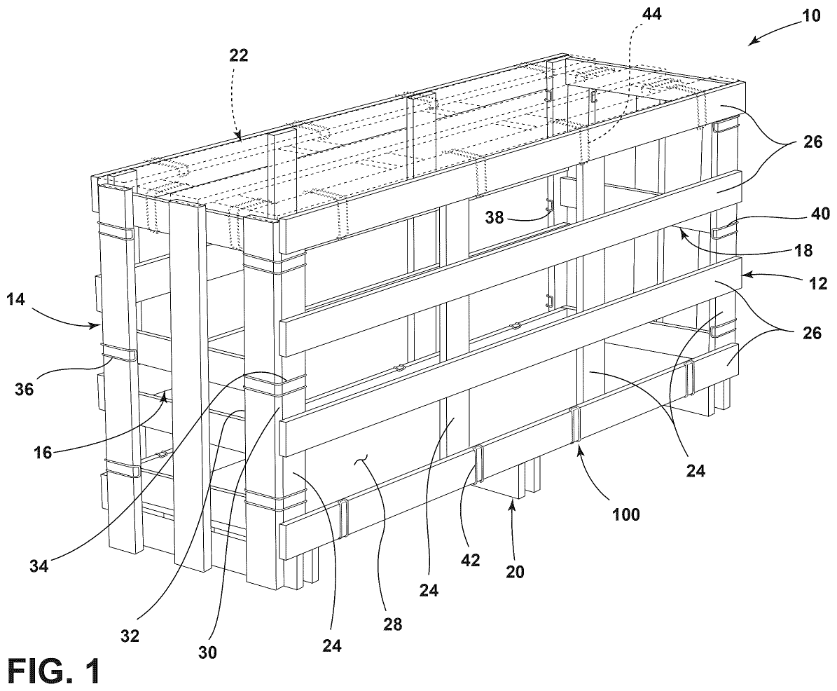

FIG. 1 illustrates a crate 10 utilizing a plurality of clamp locks 100 according to the present invention. The crate 10 is illustrated as an open sided crate having, for example, a first sidewall 12, a second sidewall 14, a third sidewall 16, a fourth sidewall 18, and a base 20. While illustrated as having four sidewalls, three sidewalls are contemplated. In a different and non-limiting example, it is further contemplated that the crate 10 can include more than four sidewalls. The first sidewall 12 can include a first set of dimensional lumber 24 and a second set of dimensional lumber 26 connecting the dimensional lumber of the first set of dimensional lumber 24. Similarly, the second sidewall 14, the third sidewall 16, and the fourth sidewall 18 can be constructed of sets of dimensional lumber.

The base 20 can include dimensional lumber and optionally include a base covering illustrated, by way of example, as a plywood floor 28. The plywood floor 28 can couple to the dimensional lumber of the base. Alternatively, the base covering can be dimensional lumber abutting or minimally spaced to form a surface.

Optionally, the crate 10 can include a top 22. The top 22 can couple to one or more of the first sidewall 12, the second sidewall 14, the third sidewall 16, or the fourth sidewall 18.

A first dimensional lumber piece 30 of the first sidewall 12 is illustrated as adjacent to a second dimensional lumber piece 32 of the second sidewall 14. As used herein, the term “adjacent” means that a surface of one object is facing, next to, or in contact with a surface of a second object. When constructing the crate 10, the first dimensional lumber piece 30 of the first sidewall 12 is adjacent to the second dimensional lumber piece 32 of the second sidewall 14. As illustrated, by way of example, the first dimensional lumber piece 30 is coupled to the adjacent second dimensional lumber piece 32 by a subset of clamp locks 34 of the plurality of clamp locks 100. That is, the subset of clamp locks 34 fits about two pieces of dimensional lumber, illustrated as the first dimensional lumber piece 30 and the second dimensional lumber piece 32, of the crate 10 to adjoin those sections or pieces together. The subset of clamp locks 34 is illustrated, by way of example as having three clamp locks, but any number of clamp locks are contemplated, including one.

Similarly, another subset of clamp locks 36 of the plurality of clamp locks 100 couple or adjoin the second sidewall 14 to the third sidewall 16. Yet another subset of clamp locks 38 couple or adjoin the third sidewall 16 and the fourth sidewall 18, and still yet another subset of clamp locks 40 couple or adjoin the fourth sidewall 18 and the first sidewall 12.

The plurality of clamp locks 100 also include subsets of clamp locks, illustrated as a base subset of clamp locks 42, that couple the base 20 to one or more of the sidewalls, illustrated, by way of example, as the first sidewall 12 and the third sidewall 16.

Optionally, the plurality of clamp locks 100 also include a top subset of clamp locks 44, that couple the top 22 to one or more of the sidewalls, illustrated, by way of example, as the first sidewall 12, the second sidewall 14, the third sidewall 16, and the fourth sidewall 18.

The plurality of clamp locks 100 or subsets of the plurality of clamp locks 100 may be used to tightly and securely connect portions or components of the crate together. The plurality of clamp locks 100 can include any number of clamp locks or any number of subset of clamp locks needed to construct the crate 10.

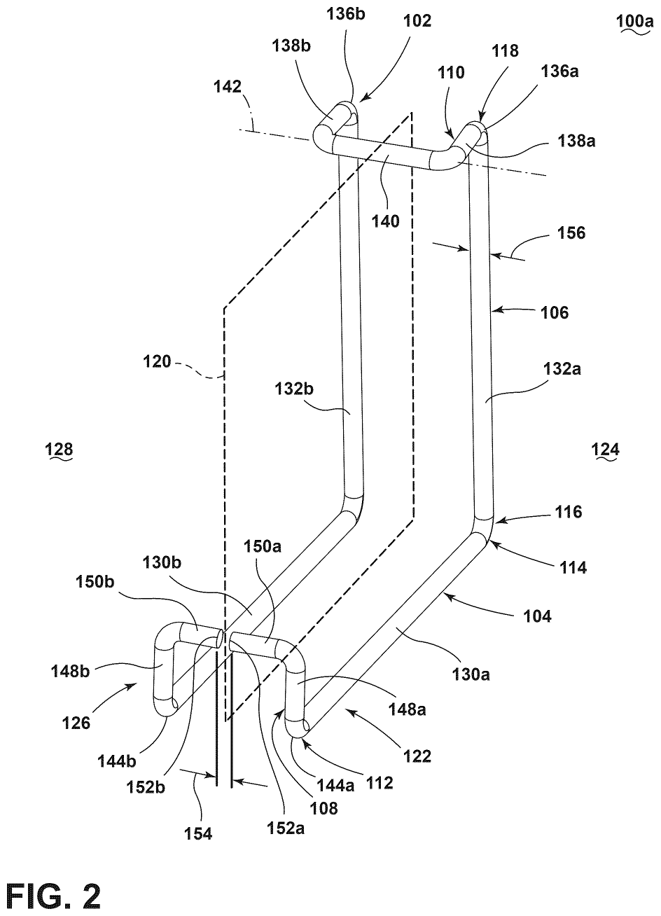

FIG. 2 illustrates perspective view of a clamp lock 100a of the plurality of clamp locks 100 (FIG. 1) according to the present invention. The clamp lock 100a is illustrated before installation on or after removal from the crate 10 (FIG. 1). That is, the clamp lock 100a, as illustrated in FIG. 2, is not retaining pieces of adjacent dimensional lumber.

The clamp lock 100a includes a body 102 having a first arm 104 having a first gripping portion 108 extending therefrom and a second arm 106 having a second gripping portion 110 extending therefrom. The first arm 104 includes a first end 112 and a second end 114. The first gripping portion 108 extends from the first end 112 of the first arm. The second arm 106 extends from the second end 114 of the first arm 104.

The second arm 106 includes a third end 116 and a fourth end 118. The third end 116 of the second arm 106 abuts the second end 114 of the first arm 104. The first arm 104 and the second arm 106 can intersect at the second end 114 and the third end 116 to form an L-shaped portion of the body 102. The second gripping portion 110 extends from the fourth end 118 of the second arm 106.

A plane 120 bisects the body 102. A first portion 122 of the body 102 is located on a first side 124 of the plane 120. A second portion 126 of the body 102 is located on a second side 128 of the plane 120. The first arm 104 is defined by a pair of spaced first segments including a first segment 130a defining part of the first portion 122 and another first segment 130b defining part of the second portion 126. The first segment 130a of the first portion 122 is spaced from the first segment 130b of the second portion 126 to give the first arm 104 a width.

Similarly, the second arm 106 is defined by a pair of spaced second segments including a second segment 132a defining part of the first portion 122 and another second segment 132b defining part of the second portion 126.

The second segment 132a of the first portion 122 extends from the first segment 130a of the first portion 122. Similarly, the second segment 132b of the second portion 126 extends from the first segment 130a of the second portion 126.

The fourth end 118 is a pair of fourth ends 136a, 136b defined by the pair of second segments 132a, 132b. The second gripping portion 110 is defined by a pair of second gripping segments 138a, 138b and a connecting segment 140. The connecting segment 140 extends through the plane 120 to connect the pair of second gripping segments 138a, 138b that extend from the pair of fourth ends 136a, 136b. The connecting segment 140 couples the first portion 122 of the body 102 to the second portion 126 of the body 102.

A connecting centerline 142 is defined by the connecting segment 140. The connecting centerline 142 can be perpendicular to the plane 120. As used herein, the term “perpendicular” implies the formation of an angle between 85 degrees and 95 degrees.

The first end 112 is a pair of first ends 144a, 144b defined by the pair of first segments 130a, 130b. The first gripping portion 108 is defined by a pair of first gripping segments 148a, 148b. A pair of prongs 150a, 150b extend towards the plane 120 from the pair of first gripping segments 148a, 148b. The pair of prongs 150a, 150b include a pair of prong ends. That is, the pair of prongs 150a, 150b include a first prong 150a having a first prong end 152a and a second prong 150b having a second prong end 152b. The first prong end 152a and the second prong end 152b define confronting prong ends 152a, 152b. The confronting first prong end 152a and second prong end 152b can abut or be spaced.

A gap distance 154 is measured between the confronting first prong end 152a and second prong end 152b. The gap distance 154 can be in a range, inclusive of endpoints, from 0 centimeters to 2 centimeters. It is contemplated that the gap distance 154 is less than or equal to a diameter 156 of the body 102. During application or removal of the clamp lock 100a, it is contemplated that the gap distance 154 can increase or decrease.

It is contemplated that the body 102 can be formed from a single piece of material extending from the first prong end 152a to the second prong end 152b. The body 102 can include, by way of example, wire having a diameter in a range, inclusive of endpoints, of 2 millimeters to 8 millimeters. The wire can be steel, being primarily made of iron and carbon. It is contemplated that the material forming the body 102 of the clamp lock 100a can include any combination of one or more of iron, carbon, chromium, nickel, manganese, molybdenum, silicon, tungsten, vanadium, boron, or aluminum. The body 102 can be formed from a single wire that forms a loop. Alternatively, the body 102 can be formed from more than one wire coupled together.

Optionally, a coating can be applied to one or more portions of the body 102. The coating can be applied to the entire wire or portions of the wire prior to forming the body 102 or applied to the entire wire or portions of the wire after forming the body 102. The coating can include, but is not limited to, zinc (e.g., plating or pre-galvanized), epoxy, polyurethane, or any combination thereof. The coating can be applied, for example, by hot dipping, spray, or electroforming, electroplating, or any combination thereof. The coating can be a plurality of coatings having similar or different materials. Each coating of the plurality of coatings can overlap, abut, or be spaced from one another.

The clamp lock 100a may be produced via CNC wire former, for example, the body 102 can be formed from a wire having a first end at the first prong end 152a and extending to define the first prong 150a, bending to extend the first gripping segment 148a from the first prong 150a, bending to extend the first segment 130a from the first gripping segment 148a, bending to extend the second segment 132a from the first segment 130a to form an L-shape, bending to extend the second gripping segment 138a from the second segment 132a, bending to extend the connecting segment 140 from the second gripping segment 138a, bending to extend the second gripping segment 138b from the connecting segment 140, bending to extend the second segment 132b from the second gripping segment 138b, bending to extend the first segment 130b from the second segment 132b to form an L-shape, bending to extend the first gripping segment 148b from the first segment 130b, bending to extend the second prong 150b from the first gripping segment 148b, and extending to the second prong end 152b of the second prong 150b.

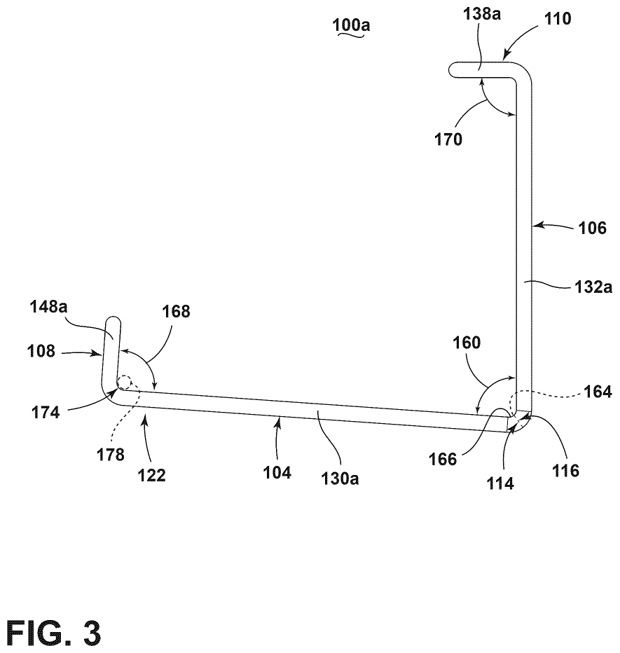

FIG. 3 is a side view of the clamp lock 100a of FIG. 2. While only the first portion 122 is visible, it is contemplated that the second portion 126 (FIG. 2) has similar dimensions to those illustrated using the first portion 122.

A central body angle 160 can be measured between the first arm 104 and the second arm 106, illustrated between the first segment 130a and the second segment 132a of the first portion 122. The central body angle 160 when the clamp lock 100a is in an unmounted position is less than 90°. For example, the central body angle 160 when the clamp lock 100a is in an unmounted position can be in a range, inclusive of endpoints, from equal to or greater than 70° to less than 90°. The central body angle 160 can change when the clamp lock 100a adjoins adjacent pieces of dimensional lumber. It is further contemplated that the central body angle 160 can be any measurement less than what is required to retain two pieces of adjacent dimensional lumber. By way of non-limiting example, if a crate model that requires five sidewalls of equal length can use clamp locks having a central body angle that measures less than 108° prior to mounting the clamp lock.

A central intersection 164 is defined by the intersection of the first arm 104 and the second arm 106 illustrated as the intersection of the first segment 130a and the second segment 132a. That is, the central intersection 164 is the abutment of the second end 114 and the third end 116. The central intersection 164 is located in a region 166 having a non-zero radius of curvature. Alternatively, the central intersection 164 can be a sharp intersection of a linear intersection having a zero radius of curvature.

A first grip angle 168 can be measured between the first gripping portion 108 and the first arm 104, illustrated between the first gripping segment 148a and the first segment 130a of the first portion 122. The first grip angle 168 when the clamp lock 100a is in an unmounted position can be in a range, inclusive of endpoints, from 80° to 100°. It is contemplated that, in a non-limiting example, the first grip angle 168 does not change more than 2% between the mounted and unmounted positions.

A first grip intersection region 174 is defined by the intersection of the first arm 104 and the first gripping portion 108, wherein the first grip intersection region 174 has a non-zero radius of curvature illustrated by circle 178.

A second grip angle 170 can be measured between the second gripping portion 110 and the second arm 106, illustrated between the second gripping segment 138a and the second segment 132a of the first portion 122. The second grip angle 170 when the clamp lock 100a is in an unmounted position can be in a range, inclusive of endpoints, from 80° to 100°. It is contemplated that, in a non-limiting example, the second grip angle 170 does not change more than 2% between the mounted and unmounted positions.

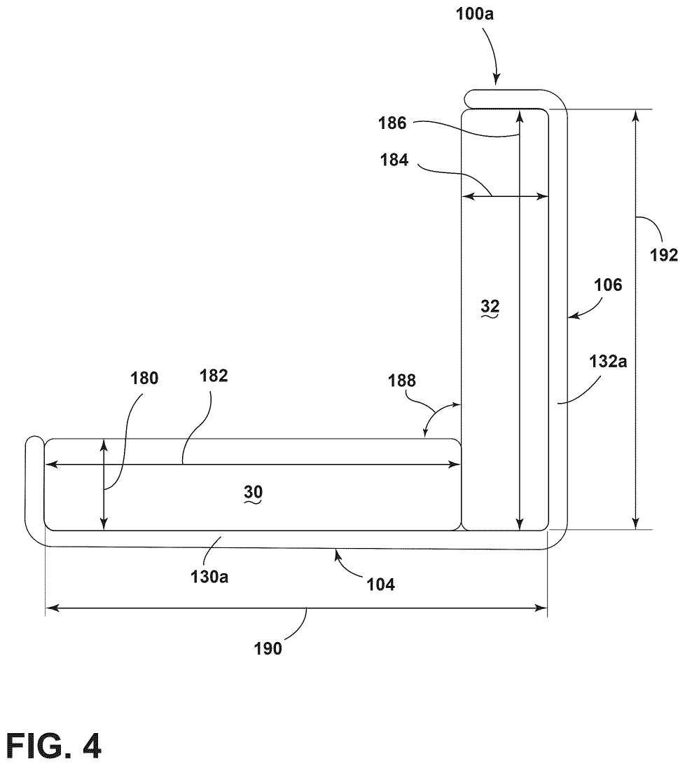

FIG. 4 illustrates the clamp lock 100a in a use or mounted position wherein the clamp lock 100a adjoins or retains two pieces of adjacent dimensional lumber, illustrated as the first dimensional lumber piece 30 and the second dimensional lumber piece 32. As illustrated, by way of example, the first dimensional lumber piece 30 and the second dimensional lumber piece 32 have the same dimensions. By way of non-limiting example, the first dimensional lumber piece 30 can be a 1×4 and have a depth 180 of 0.75 inches (approximately 1.90 centimeters) and a width 182 of 3.5 inches (8.89 centimeters). The second dimensional lumber piece 32 can optionally also, for example a 1×4. That is, the actual dimensions of the second dimensional lumber piece includes a depth 184 of 0.75 inches (approximately 1.90 centimeters) and a width 186 of 3.5 inches (8.89 centimeters). The first dimensional lumber piece 30 can be received by the first arm 104 and the second dimensional lumber piece 32 can be received by the second arm 106 and a portion of the first arm 104, such that a portion of the first dimensional lumber piece 30 is in contact with the second dimensional lumber piece 32.

A dimensional lumber angle 188 can be measured from the first dimensional lumber piece 30 supported by the first arm 104 to the abutting second dimensional lumber piece 32. The dimensional lumber angle 188 can be in a range, inclusive of endpoints, of 85 degrees and 95 degrees. That is, the first dimensional lumber piece 30 and the second dimensional lumber piece 32 are perpendicular when mounted in the clamp lock 100a.

A first segment length 190 is an interior the length of the first arm 104 or the first segment 130a. The first segment length 190 can be less than 5% longer than the width 182 of the first dimensional lumber piece 30 added to the depth 184 of the second dimensional lumber piece 32. By way of the present example, the first segment length 190 is approximately equal to, or within 5% of 4.5 inches (11.43 centimeters).

A second segment length 192 is an interior the length of the second arm 106 or the second segment 132a. The second segment length 192 can be less than 5% longer than the width 186 of the second dimensional lumber piece 32. By way of the present example, the second segment length 192 is approximately equal to, or within 5% of 3.5 inches (8.89 centimeters).

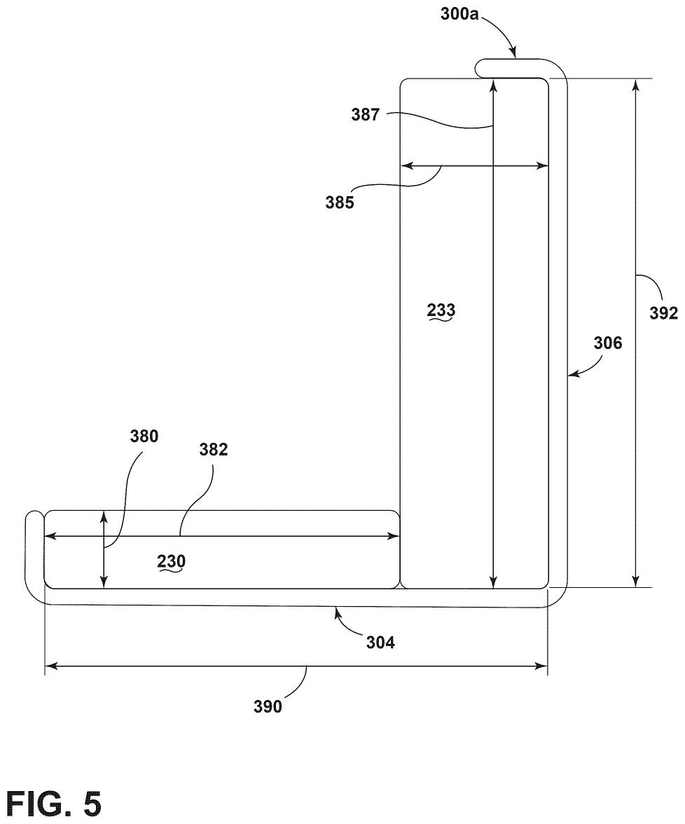

FIG. 5 illustrates a clamp lock 300a in a use or mounted position wherein the clamp lock 300a retains or adjoins two pieces of adjacent dimensional lumber, illustrated as a first dimensional lumber piece 230 and a second dimensional lumber piece 233. The clamp lock 300a is similar to the clamp lock 100a, therefore, like parts will be identified with like numerals increased by two hundred (200), with it being understood that the description of the like parts of the clamp lock 100a applies to the clamp lock 300a, unless otherwise noted.

The first dimensional lumber piece 230 can be, for example, a 1×4 and have a depth 380 of 0.75 inches (approximately 1.90 centimeters) and a width 382 of 3.5 inches (8.89 centimeters). The second dimensional lumber piece 32 can, for example a 2×6. That is, the actual dimensions of the second dimensional lumber piece includes a depth 385 of 1.5 inches (3.81 centimeters) and a width 387 of 5.5 inches (13.97 centimeters). The first dimensional lumber piece 230 can be received by a first arm 304 and the second dimensional lumber piece 233 can be received by the second arm 306 and a portion of the first arm 304, such that a portion of the first dimensional lumber piece 230 is in contact with the second dimensional lumber piece 233.

A first segment length 390 is an interior the length of the first arm 304. The first segment length 390 can be less than 5% longer than the width 382 of the first dimensional lumber piece 230 added to the depth 385 of the second dimensional lumber piece 233. By way of the present example, the first segment length 390 is approximately equal to, or within 5% of 5 inches (12.7 centimeters).

A second segment length 392 is an interior the length of the second arm 306. The second segment length 392 can be less than 5% longer than the width 387 of the second dimensional lumber piece 233. By way of the present example, the second segment length 392 is approximately equal to, or within 5% of 5.5 inches (13.97 centimeters).

It is contemplated that the first dimensional lumber piece 230 and the second dimensional lumber piece 233 are dimensional lumber, where the dimensional lumber can be one of, for example, a 1×3, a 1×4, a 1×6, a 2×3, 2×4, 2×6.

It is further contemplated that the first segment length 390 and the second segment length 392 can be lengths correspond to dimensional lumber or combinations of dimensional lumber. Table 1 illustrates possible combinations of the first segment length 390 and the second segment length 392 based on the dimensional lumber retained by the clamp lock. It will be understood that the first segment length 390 and the second segment length 392 are within 5% or less of the values listed. Further, it will be understood by one of ordinary skill in the art that the dimensions of the first segment length 390 and the second segment length 392 are not limited exclusively to these combinations of dimensional lumber.

TABLE 1

| first | second | first segment | second segment |
|---|---|---|---|
| dimensional | dimensional | length inches | length inches |
| lumber piece | lumber piece | (centimeters) | (centimeters) |
| 1 × 3 | 1 × 3 | 3.50 (8.89) | 2.75 (6.99) |
| 1 × 3 | 2 × 3 | 4.25 (10.80) | 2.75 (6.99) |
| 1 × 4 | 2 × 4 | 5.00 (12.7) | 3.50 (8.89) |
| 1 × 4 | 1 × 6 | 4.25 (10.80) | 5.50 (13.97) |
| 1 × 6 | 1 × 4 | 6.25 (15.88) | 3.50 (8.89) |
| 1 × 6 | 2 × 4 | 7.00 (17.78) | 3.50 (8.89) |
| 1 × 6 | 1 × 6 | 6.25 (15.88) | 5.50 (13.97) |
| 1 × 6 | 2 × 6 | 7.00 (17.78) | 5.50 (13.97) |

During assembly, referring to FIGS. 1-4, the model of the crate 10 is determined. Based on the model or design of the crate 10, the components are selected. That is, the number of sidewalls, base design, and optionally a top can be determined based on the pre-selected design for the crate 10.

Each component, illustrated as the first sidewall 12, the second sidewall 14, the third sidewall 16, or the fourth sidewall 18, the base 20 and the top 22 are separately pre-assembled using dimensional lumber and optionally plywood or other materials.

The dimensional lumber of adjacent components determines which clamp lock 100a, 300a is selected. That is, a size or type of the first dimensional lumber piece 30, 230 and the second dimensional lumber piece 32, 233 to be coupled can determine the first segment length 190, 390 and the second segment length 192, 392 of the clamp lock 100a, 300a.

The plurality of clamp locks 100 are available in sizes based on dimensional lumber used to construct the component. The dimensional lumber does not have to be milled, routed, or otherwise modified or reduced in size prior to mounting the clamp lock 100a, 300a. This is because the clamp lock 100a, 300a includes the first segment length 190, 390 and the second segment length 192, 392 based on the combinations of dimensional lumber used to construct or assemble the components to be coupled together to form the crate 10.

In a non-limiting example, the clamp lock 100a, 300a may be produced via CNC wire former, which allows for the clamp lock 100a, 300a to achieve any required dimensions of and angles between each of the first arm 104, the second arm 106, the first gripping portion 108, and the second gripping portion 110, or any combination thereof.

When applied, or mounted, the clamp lock 100a, 300a secures the two adjacent pieces of dimensional lumber, thus coupling the two adjacent components to form a tight and secure fit. The clamp lock 100a, 300a can be pre-sprung at a lesser angle than that of the connection point formed by the two crate components. For example, if the dimensional lumber angle 188 is 90°, the central body angle 160 of the clamp lock 100a, 300a can be less than 90°. The connected components are tightly and securely held together by a compressive force of the clamp lock 100a, 300a.

The clamp lock 100a, 300a, can be applied by applied by hand. That is, without tools, a single individual can assemble the crate 10 using the plurality of clamp locks 100 to couple adjacent pieces of the crate 10 together. In other words, the clamp lock 100a, 300a can be mounted to couple two pieces of adjacent dimensional lumber without using a screwdriver, pry bar, hammer, or other tool.

When the clamp lock 100a, 300a is mounted, the two crate components can connected form a 90° angle. However, it is contemplated that the two crate components can be connected to form angles other than 90° and are still connected by the clamp lock 100a, 300a to form a tight and secure fit via a compressive force.

More specifically, the first dimensional lumber piece 30, 230 can be placed between one of the first gripping portion 108 or the second gripping portion 110 and the opposing second arm 106 or first arm 104. By way of non-limiting example, when mounting the clamp lock 100a, 300a, a user may place the second dimensional lumber piece 32, 233 in the clamp lock 100a, 300a such that an edge parallel to the depth 184, 385 is in contact with or adjacent the second gripping portion 110 defined by the pair of second gripping segments 138a, 138b. An edge parallel to the width 186, 387 can be brought into contact with the second arm 106 defined by the pair of second segments 132a, 132b. The edge opposite that adjacent the edge in contact with or adjacent the second gripping portion 110 can be in contact with or adjacent with the first arm 104. That is, the first dimensional lumber piece 30, 230 is located in contact with the second gripping portion 110 and between the second gripping portion 110 and the first arm 104.

Similarly, the user may place the first dimensional lumber piece 30, 230 in the clamp lock 100a, 300a such that an edge parallel to the depth 180, 380 is in contact with or adjacent the first gripping portion 108 defined by the pair of first gripping segments 148a, 148b. An edge parallel to the width 182, 382 can be brought into contact with the first arm 104 defined by the pair of first segments 130a, 130b. That is, the first dimensional lumber piece 30, 230 is located in contact with the first gripping portion 108 and between the first gripping portion 108 and the second arm 106.

Benefits of aspects of the clamp lock disclosed herein include that the dimensions and angles of the clamp lock are such that two pieces of dimensional lumber can be secured with a tight fit. Prior to this design, dimensional lumber had to be milled to fit conventional fasteners. There has been a long-felt but unmet need in the market for an alternative, which allowed for a clamp fastener that did not require milling or other weakening of the dimensional lumber. Since at least the 1960s, open crating production companies have been milling down 1×6s or using 5/4×4s to fit the existing clamps on the market. This is costly and wasteful. Further still, conventional use of such fasteners often resulted in a loose and unsafe fit.

Consumers, including but not limited to crate manufacturers, have been waiting for a solution like this for over a half-century. Such solutions provide a tool free, low cost, safer alternative to previous clamp fasteners and nail/staple gun assembled crating. In many cases conventional fasteners wasted countless resources in trying to make the existing style clamp work. Further still, the ability to use unaltered dimensional lumber allows for the creation of strong crates with less weak spots and defects.

While the invention has been specifically described in connection with certain specific embodiments thereof, it is to be understood that this is by way of illustration and not of limitation. Reasonable variation and modification are possible with the scope of the foregoing disclosure and drawings without departing from the spirit of the invention which is defined in the appended claims. Hence, specific dimensions and other physical characteristics relating to the embodiments disclosed herein are not to be considered as limiting, unless the claims expressly state otherwise.

Further aspects of the disclosure are provided by the subject matter of the following clauses:

A clamp lock comprising a body comprising a first arm including a first end and a second end, a second arm including a third end and a fourth end, wherein the second arm extends from the second end of the first arm, a first gripping portion extending from the first end of the first arm, wherein a first grip angle between the first gripping portion and the first arm is in a range, inclusive of endpoints, from 80° to 100°, and a second gripping portion extending from the fourth end of the second arm, wherein a second grip angle between the second gripping portion and the second arm is in a range, inclusive of endpoints, from 80° to 100°.

The clamp lock of any preceding clause, wherein a plane bisects the body, wherein a first portion of the body is located on a first side of the plane and a second portion of the body is located on a second side of the plane, wherein the first arm is defined by a pair of spaced first segments including a first segment defining part of the first portion and another first segment defining part of the second portion, where the first segment of the first portion is spaced from the first segment of the second portion.

The clamp lock of any preceding clause, wherein the second arm is defined by a pair of spaced second segments including a second segment defining part of the first portion and another second segment defining part of the second portion, where the second segment of the first portion extends from the first segment of the first portion and the second segment of the second portion, spaced from the second segment of the first portion, extends from the first segment of the second portion.

The clamp lock of any preceding clause, wherein the fourth end is a pair of fourth ends defined by the pair of second segments, wherein the second gripping portion is defined by a pair of second gripping segments and a connecting segment, wherein the pair of fourth ends are coupled by the pair of second gripping segments and the connecting segment that extends between the pair of second gripping segments.

The clamp lock of any preceding clause, further comprising a connecting centerline that is defined by the connecting segment, wherein the connecting centerline is perpendicular to the plane.

The clamp lock of any preceding clause, wherein the second gripping portion is defined by a pair of second gripping segments and a connecting segment, wherein the connecting segment couples the first portion to the second portion.

The clamp lock of any preceding clause, wherein the first end is a pair of first ends defined by the pair of first segments, wherein the first gripping portion is defined by a pair of first gripping segments and a pair of prongs, wherein the pair of prongs include a first prong having a first prong end and a second prong having a second prong end, and wherein the first prong end and the second prong end define confronting prong ends.

The clamp lock of any preceding clause, wherein the confronting prong ends abut or are spaced.

The clamp lock of any preceding clause, wherein a single wire extends from the first prong end to the second prong end.

The clamp lock of any preceding clause, wherein a gap distance is measured between the confronting prong ends.

The clamp lock of any preceding clause, wherein a central body angle is measured from the first arm to the second arm, wherein the central body angle is in a range, inclusive of endpoints, from 70° to 90°.

The clamp lock of any preceding clause, wherein a central intersection is defined by an intersection of the first arm and the second arm, wherein the central intersection is located in a region having a non-zero radius of curvature.

The clamp lock of any preceding clause, wherein a first grip intersection is defined by an intersection of the first arm and the first gripping portion, wherein the first grip intersection has a non-zero radius of curvature.

The clamp lock of any preceding clause, wherein the first arm has a first segment length and the second arm has a second segment length, wherein the first segment length and the second segment length are within 5% of a width of a first dimensional lumber piece plus a depth of a second dimensional lumber piece, or a width of the second dimensional lumber piece.

The clamp lock of any preceding clause, wherein the first dimensional lumber piece or the second dimensional lumber piece are one of a 1×3, 1×4, 1×6, 2×3, 2×4, 2×6, or 4×4.

The clamp lock of any preceding clause, wherein the first arm and the first gripping portion receive a first dimensional lumber piece and the second gripping portion and the second arm receive a second dimensional lumber piece, wherein the first dimensional lumber piece is in contact with the first gripping portion and adjacent the first arm, and the second dimensional lumber piece is in contact with the second gripping portion and adjacent the second arm and the first arm.

The clamp lock of any preceding clause, wherein at least a portion of the body includes a coating.

A crate having at least four components, wherein the four components include a plurality of dimensional lumber pieces, and wherein a plurality of clamp locks couple two dimensional lumber pieces of the plurality of dimensional lumber pieces, wherein the two dimensional lumber pieces define different components of the crate, each clamp lock of the plurality of clamp locks comprising a body comprising a first arm including a first end and a second end, a second arm including a third end and a fourth end, wherein the second arm extends from the second end of the first arm, a first gripping portion extending from the first end of the first arm, wherein a first grip angle between the first gripping portion and the first arm is in a range, inclusive of endpoints, from 80° to 100°, and a second gripping portion extending from the fourth end of the second arm, wherein a second grip angle between the second gripping portion and the second arm is in a range, inclusive of endpoints, from 80° to 100°.

The crate of any preceding clause, wherein the first arm has a first segment length and the second arm has a second segment length, wherein the first segment length and the second segment length are within 5% of a width of a first dimensional lumber piece plus a depth of a second dimensional lumber piece, or a width of the second dimensional lumber piece.

The crate of any preceding clause, wherein a central body angle is measured from the first arm to the second arm, wherein the central body angle is in a range, inclusive of endpoints, from 70° to 90°.

The crate of any preceding clause, wherein the two dimensional lumber pieces are not milled, routed, or otherwise reduced in size.

What is claimed is:

1. A clamp lock comprising:
a body comprising:
a first arm including a first end and a second end;
a second arm including a third end and a fourth end, wherein the second arm extends from the second end of the first arm;
a first gripping portion extending from the first end of the first arm, wherein a first grip angle between the first gripping portion and the first arm is in a range, inclusive of endpoints, from 80° to 100°; and
a second gripping portion extending from the fourth end of the second arm, wherein a second grip angle between the second gripping portion and the second arm is in a range, inclusive of endpoints, from 80° to 100°.

2. The clamp lock of claim 1, wherein a plane bisects the body, wherein a first portion of the body is located on a first side of the plane and a second portion of the body is located on a second side of the plane, wherein the first arm is defined by a pair of spaced first segments including a first segment defining part of the first portion and another first segment defining part of the second portion, where the first segment of the first portion is spaced from the first segment of the second portion.

3. The clamp lock of claim 2, wherein the second arm is defined by a pair of spaced second segments including a second segment defining part of the first portion and another second segment defining part of the second portion, where the second segment of the first portion extends from the first segment of the first portion and the second segment of the second portion, spaced from the second segment of the first portion, extends from the first segment of the second portion.

4. The clamp lock of claim 3, wherein the fourth end is a pair of fourth ends defined by the pair of second segments, wherein the second gripping portion is defined by a pair of second gripping segments and a connecting segment, wherein the pair of fourth ends are coupled by the pair of second gripping segments and the connecting segment that extends between the pair of second gripping segments.

5. The clamp lock of claim 4, further comprising a connecting centerline that is defined by the connecting segment, wherein the connecting centerline is perpendicular to the plane.

6. The clamp lock of claim 3, wherein the second gripping portion is defined by a pair of second gripping segments and a connecting segment, wherein the connecting segment couples the first portion to the second portion.

7. The clamp lock of claim 3, wherein the first end is a pair of first ends defined by the pair of first segments, wherein the first gripping portion is defined by a pair of first gripping segments and a pair of prongs, wherein the pair of prongs include a first prong having a first prong end and a second prong having a second prong end, and wherein the first prong end and the second prong end define confronting prong ends.

8. The clamp lock of claim 7, wherein the confronting prong ends abut or are spaced.

9. The clamp lock of claim 7, wherein a single wire extends from the first prong end to the second prong end.

10. The clamp lock of claim 7, wherein a gap distance is measured between the confronting prong ends.

11. The clamp lock of claim 1, wherein a central body angle is measured from the first arm to the second arm, wherein the central body angle is in a range, inclusive of endpoints, from 70° to 90°.

12. The clamp lock of claim 1, wherein a central intersection is defined by an intersection of the first arm and the second arm, wherein the central intersection is located in a region having a non-zero radius of curvature.

13. The clamp lock of claim 1, wherein a first grip intersection is defined by an intersection of the first arm and the first gripping portion, wherein the first grip intersection has a non-zero radius of curvature.

14. The clamp lock of claim 1, wherein the first arm has a first segment length and the second arm has a second segment length, wherein the first segment length and the second segment length are within 5% of a width of a first dimensional lumber piece plus a depth of a second dimensional lumber piece, or a width of the second dimensional lumber piece.

15. The clamp lock of claim 14, wherein the first dimensional lumber piece or the second dimensional lumber piece are one of a 1×3, 1×4, 1×6, 2×3, 2×4, 2×6, or 4×4.

16. The clamp lock of claim 1, wherein the first arm and the first gripping portion receive a first dimensional lumber piece and the second gripping portion and the second arm receive a second dimensional lumber piece, wherein the first dimensional lumber piece is in contact with the first gripping portion and adjacent the first arm, and the second dimensional lumber piece is in contact with the second gripping portion and adjacent the second arm and the first arm.

17. A crate having at least four components, wherein the four components include a plurality of dimensional lumber pieces, and wherein a plurality of clamp locks couple two dimensional lumber pieces of the plurality of dimensional lumber pieces, wherein the two dimensional lumber pieces define different components of the crate, each clamp lock of the plurality of clamp locks comprising:
a body comprising:
a first arm including a first end and a second end;
a second arm including a third end and a fourth end, wherein the second arm extends from the second end of the first arm;
a first gripping portion extending from the first end of the first arm, wherein a first grip angle between the first gripping portion and the first arm is in a range, inclusive of endpoints, from 80° to 100°; and
a second gripping portion extending from the fourth end of the second arm, wherein a second grip angle between the second gripping portion and the second arm is in a range, inclusive of endpoints, from 80° to 100°.

18. The crate of claim 17, wherein the first arm has a first segment length and the second arm has a second segment length, wherein the first segment length and the second segment length are within 5% of a width of a first dimensional lumber piece plus a depth of a second dimensional lumber piece, or a width of the second dimensional lumber piece.

19. The crate of claim 17, wherein a central body angle is measured from the first arm to the second arm, wherein the central body angle is in a range, inclusive of endpoints, from 70° to 90°.

20. The crate of claim 17, wherein the two dimensional lumber pieces are not milled, routed, or otherwise reduced in size.
